(19) United States
(12) Patent Application Publication
(10) Pub. No.: US 2003/0219198 A1
(43) Pub. Date: Nov. 27, 2003

(54) Routing in optical networks considering transmission impairments

(75) Inventor: Jianying Zhou, Acton, MA (US)

Correspondence Address: LAHIVE & COCKFIELD, 28 STATE STREET, BOSTON, MA, 02109, US

(73) Assignee: Sycamore Networks, Inc., Chelmsford, MA (US)

(21) Appl. No.: 10/154,223

(22) Filed: May 22, 2002

(51) Int. Cl. G02B 6/28

(52) U.S. Cl. 385/24

(57) ABSTRACT

A method of dispersion compensation for an optical network divides the optical fiber transmission line into sections located between a pair of re-configurable nodes. For each section, at either one of the pair of nodes, wavelengths are classified into a first set of added waves, a second set of dropped waves and a third set of express waves. A first predetermined dispersion compensation is provided to the third set of express waves so that the third set of express waves have a second predetermined dispersion. Methods for determining linear and nonlinear impairment parameters so that the optical parameters due to both linear and nonlinear transmission impairments of each section can be independent obtained and disseminated throughout the network.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

This invention relates generally to a re-configurable optical layer in an optical network and more particularly to methods of dividing transmission lines into sections between re-configurable nodes so that the optical physical parameters of each section can be independently calculated and disseminated throughout the network.

### BACKGROUND OF THE INVENTION

Dense Wavelength Division Multiplexing (DWDM) is a technology for optical communications which uses densely packed wavelengths of light to effectively multiply the capacity of the fiber. Each wavelength carries a distinct signal. The performance of such systems is first limited by optical attenuation, which progressively weakens the optical strength of the signals as they propagate along the fiber. DWDM optical communications systems are practical because of the use of optical amplifiers which restore the strength of all wavelengths in the signals simultaneously, to counteract the effects of optical attenuation. Amplifiers are typically selected to provide suitable amplification to restore the signal.

The most commonly deployed optical amplifier is an Erbium-Doped Fiber Amplifier (EDFA). A typical conventional band (C-band) EDFA operates in the range of approximately 1528-1563 nm. Other types of optical amplifiers, such as L-band and S-band can, extend the wavelength range for WDM transmission. For example, new L-band EDFAs operate in the range of approximately 1567-1605 nm. It is a fundamental property of optical amplifiers that in addition to delivering signal gain, they also produce noise, i.e. amplified spontaneous emission (ASE), which degrades the signal quality. For economic reasons, it is desirable that the lengths of transmission fiber between these optical amplifiers be as large as possible. However, the further the signals must travel from one optical amplifier to the next, the more the signals weaken due to optical attenuation, and the more severely the noise added at each amplifier degrades the signal. In addition, each WDM signal will experience different gain and noise due to non-ideal gain flatness of the optical amplifier; optical equalization is needed after a certain number of he cascaded optical amplifiers in order to guarantee that all WDM signal can reach the same transmission performances. The distances over which such signals can be transmitted are generally limited by the accumulation of such noise.

The quality of the signal at the end of the system can be improved by increasing the optical power produced by each optical amplifier. In practical systems, the ability to increase optical power is constrained. Specifically, when the optical powers of signals in the channels in the fiber exceed a certain level, they create optical nonlinear effects (such as self phase modulation (SPM), cross phase modulation (CPM), four wave mixing, Stimulated Brillouin Scattering (SBS), and Stimulated Raman Scattering (SRS)) which distort the signals and impair their quality. Thus, it is very important to minimize the impairments arising from optical noise without increasing the optical power beyond the nonlinear limit.

The capacity of optical fibers to carry signals may be increased by using DWDM technology but also by employing Time Division Multiplexing (TDM) (i.e. multiplexing time-tributary signals at lower bit rates into multiplexed aggregated signal streams at higher bit rates which are transmitted over the fiber as a single serial stream of bits at the aggregated rate). The extent of such multiplexing is limited in part by the ability to process, produce and detect such high speed Time Division Multiplexed signal streams but even more so by the ability of such very short pulses to maintain their integrity while propagating along long lengths of transmission optical fiber.

The most severe impairment limiting the data rate of TDM signal channels is chromatic dispersion. Chromatic dispersion is a property of the optical fiber which causes light of different wavelengths to propagate at different speeds. Any optical pulse is made up of light of a range of wavelengths and the shorter the pulse, the wider the range of wavelengths which make up the pulse. In the presence of chromatic dispersion, these wavelengths propagate at different speeds and this causes the pulse to spread out in time. The signal is impaired when the pulses spread sufficiently that they overlap with the neighboring preceding or subsequent pulses and can no longer be distinguished by the receiver. Various commercial fibers such as SMF, LEAF and TWRS have different dispersion characteristics as shown in FIG. 1. Dispersion compensation, which reverses the impairment caused by dispersion, is a key technology for the transmission of high-speed TDM signals (i.e., 10 Gb/s, 40 Gb/s and more). A dispersion compensating fiber (DCF) is a fiber specially designed to have chromatic dispersion with a sign opposite to that of transmission fibers. Pulses which have been dispersed (i.e., broadened in time) by propagating over a dispersion optical fiber can be narrowed to their original width, and thus, the integrity of the signal is restored.

Wavelength-division multiplexing (WDM) has been extensively deployed within today's transport networks. The emerging of the new re-configurable optical nodes, such as optical add/drop nodes (OADNs), optical equalization nodes (OEQNs) and optical junction nodes (OJNs), which can be interconnected via WDM links into these networks offers promising re-configurable optical networks, that have the potential to provide on demand establishment of high-bandwidth connections (e.g., lightpaths) and wavelength routing due to changing traffic demand and/or optical restoration/protection. A result of these new technologies is the evolution of optical transport networks from simple linear and ring topologies to mesh topologies. Underscoring the importance of versatile networking capabilities in the optical domain, a number of standardization organizations and interoperability forums have initiated work items to study the requirements and architectures for re-configurable optical networks. Refer, for example, to ITU-T recommendation G.872.

Critical to these efforts are improvements to the “Optical Layer Control Plan” —the software used to determine routing and to establish and maintain connections. Traditional centralized transport operations systems are widely acknowledged to be incapable of scaling to meet exploding demand or establishing connections as rapidly as needed. Consequently, much attention has been paid recently to new control plane architectures based on data networking protocols such as multiprotocol label switching (MPLS) and Open Shortest Path First (OSPF). The flow of data, such as available bandwidth for each link, through a mesh optical network is accomplished by transmitting data from one node to the next until the destination is reached. Each node can perform calculations to determine the optimal (such as shortest) path to the destination node based on the global network topology. In link-state routing protocols, the existence of various nodes and connections (or links) in the network are advertised to other nodes in the network. Thus, each router learns the topology of the network. Knowledge of the network topology is used by each node to determine the best path for a particular destination. An example of a link-state routing protocol is the Open Shortest Path First (OSPF) routing protocol. Each node running the OSPF protocol maintains an identical database describing the network topology.

To date, however, little attention has been paid to aspects of the optical layer which differ from those found in data networking, such as transmission impairments. Transmission impairments can be classified into two categories: linear and nonlinear. Linear effects are independent of signal power and affect wavelengths individually (such as Amplifier spontaneous emission (ASE) and Chromatic Dispersion (CD)). Nonlinearities (such as Self-phase modulation (SPM), cross phase modulation (CPM), four wave mixing (FWM), Stimulated Raman Scattering (SRS), polarization mode dispersion (PMD)), are significantly more complex. They generally not only have the impact on the signal quality of the single channel, but also cause the interactions between channels. In other words, signal power, channel spacing, channel plan, etc. all have impact on nonlinearities which adversely effect the signal performance. So when nonlinearities cannot be ignored for certain fiber types, signal transmission formats, channel plans and channel spacing, nonlinearities have to be specifically taken into consideration for the transmission links.

Optical performance is dependent on optical noise and signal distortion. Optical noise is due primarily to the amplified emission noise (ASE) in the optical amplified WDM links and can be characterized by an optical signal-to-noise ratio (OSNR), while the signal distortion is caused mainly by chromatic dispersion and nonlinear impairments. So the optical performance defined in terms of optical power and optical signal-to-noise ratio (OSNR), along with nonlinear impairments, directly affect the channel's transmission performance, defined in terms of its bit error rate (BER) and system Q-value. Since BER and Q include all the effects of all transmission impairments, not just those relating to optical power and OSNR, altering the optical power alone will not provide the required changes in BER performance under all typical circumstances, which effectively attempts to optimize a multi-variable problem by changing one variable. Other variables such as channel spacing, channel plan, etc., have to be taken into consideration. So the transmission performances of WDM links can be maintained by keeping it's the OSNR for the links in a certain range while maintaining the nonlinear impairment at certain level by controlling factors like channel spacing, channel plan, etc., which contribute to nonlinear impairments.

FIG. 2A illustrates one way of viewing the relationship between WDM section optical performance and nonlinear impairments. As is evident from FIG. 2A, there is a trade-off between optical signal performance, OSNR, Nonlinear impairments (NI) and Q-value (as function of signal power). The end-to-end system transmission performance Q-value or BER-value is dependent on the impact from both OSNR and NI. In general, the Q-value will increase with OSNR but will decrease due to a penalty caused by the NI. Furthermore, the NI are not only a function of signal power but also a function of channel spacing, channel plan, fiber type, DCF type, OSNR, etc. FIG. 2A shows that the OSNR will initially increase with an increase in the channel power; however, the NI will increase as well, which will cause a Q-value decrease. As shown in FIG. 3A, signal power which is accessable in the re-configurable nodes can be adjusted to compromise signal OSNR and signal transmission conditions such as channel spacing (such as 50 GHz or 25 GHz spacing), channel counts (160 waves, 80 waves or 40 waves) as well as a special channel plan to control the nonlinear impairments for different fiber types. In FIG. 2A, A* represents a preferred compromise point but other choices such as A1 or A2 or a continues range from A1 to A2 are also possible. Note that since NI is a multi-variable function, a single, multiple or a continuous range of channel power will have a single, multiple or a continuous range of other variables such as Channel Spacing, Channel Plan, Fiber Types, DCF types, OSNR, . . . that correspond. The relationship can be represented in a variety of forms such as a list, a formula, a table, an array, etc.

Transmission impairments lead to constraints that can couple routes together and can lead to complex dependencies, (e.g. on the order in which specific fiber types and lengths are traversed). From a routing, network management & control perspective, the key is to make the transmission section attributes such as bandwidth, available wavelengths, and linear & nonlinear impairments independent from each other so that they can be disseminated throughout the network.

It would, therefore, be desirable to provide methods for dividing a transmission line into sections so that the optical parameters due to linear transmission impairments (such as ASE and CD) of each section can be independently obtained and disseminated throughout the network.

It would also be desirable to provide methods for dividing a transmission line into sections so that the optical parameters due to nonlinear transmission impairments (such as SPM, CPM, FWM, SRS, SBS, PMD etc.) for each section can be independently obtained and disseminated throughout the network.

### SUMMARY OF THE INVENTION

The present invention provides methods for dividing a transmission line into sections so that the optical parameters due to both linear and nonlinear transmission impairments of each section can be independently obtained and disseminated throughout the network.

A method of dispersion compensation for an optical network with a plurality of re-configurable nodes having an optical fiber transmission line, carrying an optical signal with a plurality of wavelengths, divides the optical fiber transmission line into a plurality of sections located between a pair of the plurality re-configurable nodes. For each section, at either one of the pair of nodes a plurality of wavelengths are classified into a first set of added waves, a second set of dropped waves and a third set of express waves. A first predetermined dispersion compensation is provided to the third set of express waves so that the third set of express waves have a second predetermined dispersion.

A method of determining linear impairment parameters for an optical network with a plurality of re-configurable nodes having an optical fiber transmission line carrying an optical signal with a plurality of wavelengths, divides the optical fiber transmission line into a plurality of sections. The sections are located between a pair of the plurality re-configurable nodes. Linear impairment parameters are determined for each section.

A method of determining nonlinear impairment parameters for an optical network with a plurality of re-configurable nodes having an optical fiber transmission line, carrying an optical signal, divides the optical fiber transmission line into a plurality of sections. The section are located between a pair of the plurality re-configurable nodes; for each said section, a trade-off relationship between the optical performance metric and nonlinear impairment impact for the optical signal when traveling through the section is determined.

A re-configurable optical node is provided with a plurality of ports connected to a plurality of fibers. Each fiber carries a plurality of wavelengths. The node has a first device for dropping a first set of waves from the wavelengths and a second device for adding a second set of waves to the wavelengths. The node also includes a third device located between the first and second device for directing a third set of express waves. A dispersion compensating device is located between the first device and the third device for providing a predetermined dispersion compensation to the third set of express waves.

A re-configurable optical node in an optical network carries an optical signal with a plurality of wavelengths. The nodes includes a first device for decomposing the optical signal and optionally dropping a first set of waves from the wavelengths. A second device is also included for combining the wavelengths into the optical signal and optionally adding a second set of waves to the wavelengths. A dispersion compensating device is located between the first device and the second device for providing a predetermined dispersion compensation to a third set of express waves.

A method for routing in an optical network having a plurality of re-configurable nodes with an optical fiber transmission line, divides the optical fiber transmission line into a plurality of sections. The sections are located between a pair of the plurality re-configurable nodes. A set of attributes are defined for the sections. The attributes include transmission impairments parameters. The attributes are disseminated to the nodes in the optical network.

### BRIEF DESCRIPTION OF THE DRAWINGS

The invention will be more fully understood from the following detailed description taken in conjunction with the accompanying drawings, in which:

FIG. 1 shows fibers with different dispersion characteristics.

FIG. 2A illustrates a trade-off relationship between signal optical performance OSNR, Nonlinear impairment NI and Q-value as a function of signal power.

FIG. 2B shows residual dispersion and a dispersion window.

FIG. 3 shows a portion of a typical optical mesh network with re-configurable nodes and waves.

FIG. 4A shows the residual dispersion for added waves, dropped waves and express waves in a re-configurable optical node based on current point-to-point link dispersion compensation strategy.

FIG. 4B shows the residual dispersion for added waves, dropped waves and express waves in a re-configurable optical node in accordance with an embodiment of the present invention.

FIG. 5A shows an illustrative section of transmission line of a mesh optical network with four re-configurable nodes and four waves.

FIG. 5B illustrates the dispersion map for an express wave in accordance with an embodiment of the present invention.

FIG. 6A shows an OADN with a DCF to provide dispersion compensation for the express waves in accordance with one embodiment of the present invention.

FIG. 6B shows an OJN with a DCF to provide dispersion compensation for the express waves in accordance with one embodiment of the present invention.

FIG. 7 illustrates an optical network with a plurality of re-configurable nodes and divided sections in accordance with an embodiment of the present invention.

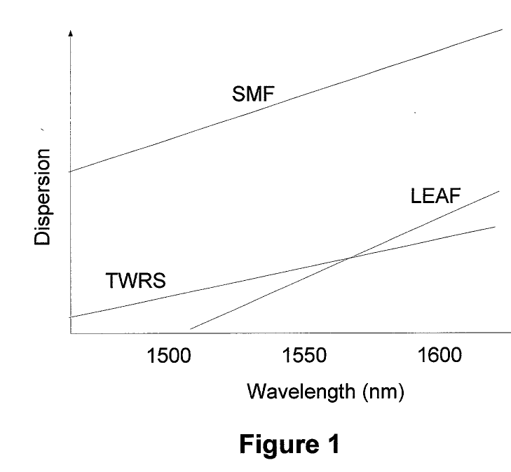

### DETAILED DESCRIPTION OF THE INVENTION

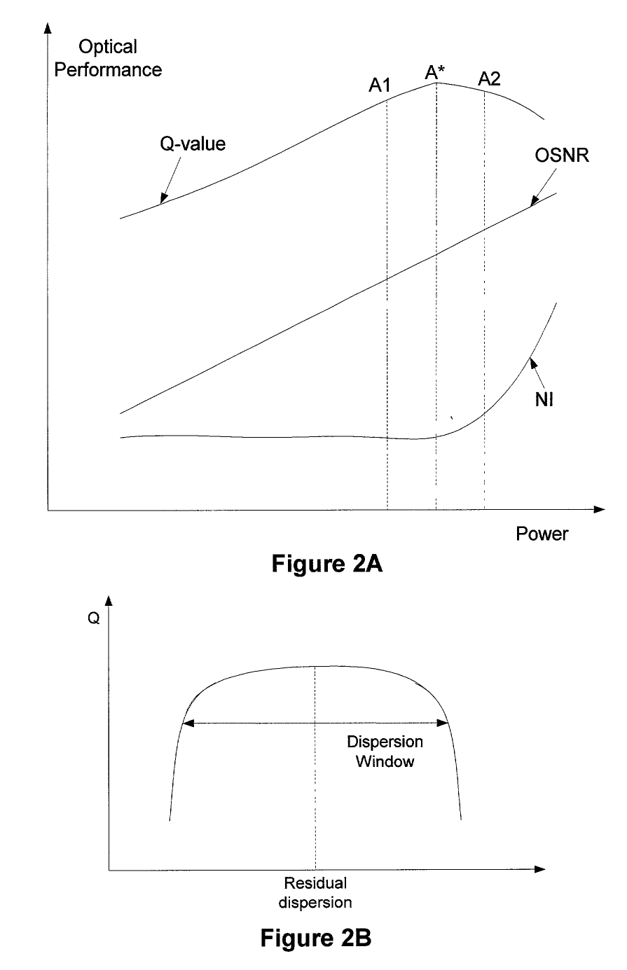

Dispersion compensation is required for high bit rate transmission systems (10 Gb/s and above), to compensate for the accumulated dispersion effects from the transmission fiber. Dispersion compensation is well understood for point-to-point links in an optical transmission system, and typically involves the use of dispersion compensating fibers, FBGs or other technologies at various locations in the transmission system. For commonly used non-return-to-zero (NRZ) modulation schemes, studies have shown that a small amount of accumulated chromatic dispersion (called residual dispersion) results in the best transmission characteristics. The residual dispersion has to be confined in a “dispersion window.” The amount of residual dispersion depends on many factors, such as the fiber length of the system, the fiber type used in the system, dispersion compensation technologies employed. The window can be determined by the transmitter and receiver performances, the wavelength dependence of the transmission fibers and dispersion compensation fibers, fiber non-linearity, and other factors. Emerging network architectures envision the use of re-configurable optical nodes in a mesh network. In this architecture, the optical waves in the fibers are not necessarily terminated at every node—instead, they either be patched through the node or switched through to another fiber direction. Hence, it can be seen that in a mesh network, a lightpath can be established over many links, and appropriate dispersion compensation has to be guaranteed for the link to work properly. FIG. 2B shows residual dispersion and a dispersion window.

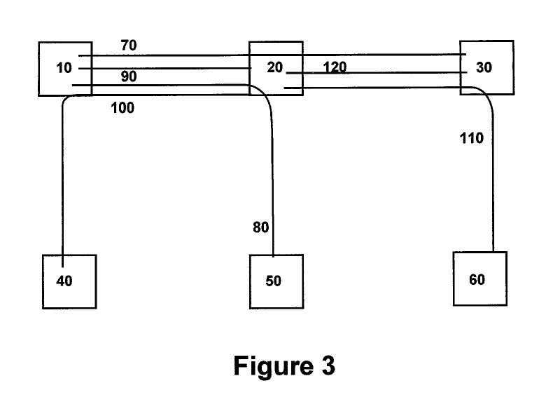

FIG. 3 shows a portion of an optical mesh network with re-configurable optical nodes 10, 20, 30, 40, 50 and 60 and a number of optical signals or waves 70, 80, 90, 100, 110 and 120 that are transmitted among the nodes. Express wave 70 starts from node 10, passes node 20 and ends at node 30. Express wave 80 starts from node 10, passes node 20 and ends at node 50. Express wave 100 starts from node 40, passes node 10, ends at node 20. Express wave 110 starts from node 20, passes node 30, ends at node 60. Wave 90 starts from node 10 ends at node 20. Wave 120 starts from node 20 and ends at node 30.

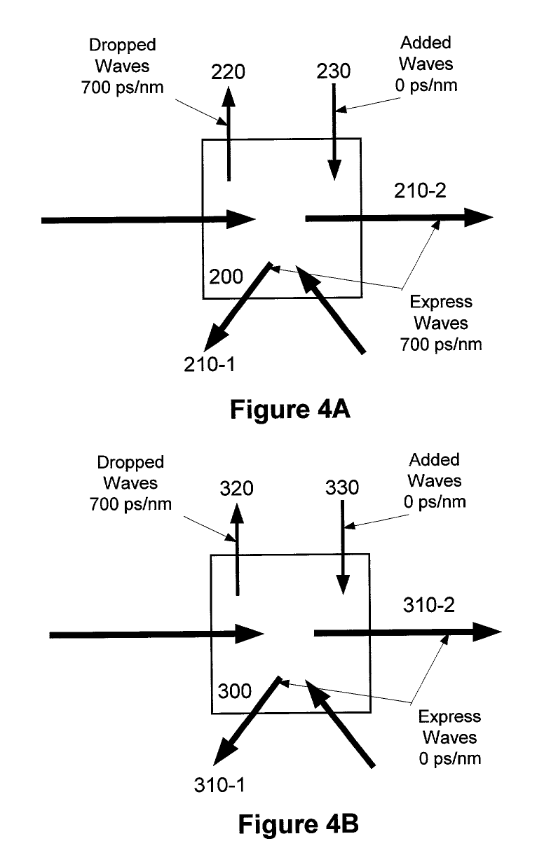

In the most general case, the fiber types and distances between the links are different. In the FIG. 3 example, suppose that all fibers are the same type (say SMF), and each of the segments is 1000 Km in length. This network cannot be designed in the same way a point-to-point links are designed. For a point-to-point link for length of 1000 Km, the link is designed with no pre-compensation and with a residual dispersion of about 700 ps/nm. If the link connecting nodes 10 to 20 and the link connecting nodes 20 to 30 were designed this way, the waves 90 and 120 would be fine, but wave 70 which goes from nodes 10 to 30, sees a residual dispersion of 1400 ps/nm, which is too high compared to an optimal value of 700 ps/nm for a distance of 2000 Km. It can be seen from FIG. 3 that similar problem exists for the other express waves 80, 100, and 110. Therefore, the conventional dispersion compensation strategy has to be modified to support the design of the new mesh network architecture with express lightpaths. FIG. 3 illustrates inconsistent dispersion compensation between express waves and dropped waves. In order to simplify the dispersion design and control, the illustrative embodiment of the present invention relates to the methods and apparatus which provide the residual dispersion of the express waves at a predetermined value, such as zero ps/nm, before being combined with added waves. For comparison, FIG. 4A shows the residual dispersion for added waves 220, dropped waves 230 and express waves 210-1 and 210-2, in a re-configurable optical node 200 based on current point-to-point link dispersion compensation strategy. For the simplicity of illustration, consider that all links have the same type of fiber (such as a single mode fiber (SMF)), and each of the segments for added, dropped and express waves is 1000 Km in length. The link is designed with no pre-compensation and with a residual dispersion of about 700 ps/nm for dropped and express waves and zero ps/nm for added waves.

FIG. 4B shows the residual dispersion for added waves 320, dropped waves 330 and express waves 310-1 and 310-2 in a re-configurable optical node 300 in accordance with an embodiment of the present invention. Similar to FIG. 4A, the link is designed with no pre-compensation and with a residual dispersion of about 700 ps/nm for dropped waves and zero ps/nm for added waves. But the express waves are compensated to have a predetermined dispersion value (for the simplicity of illustration, FIG. 4B uses zero ps/nm) as the predetermined dispersion value.

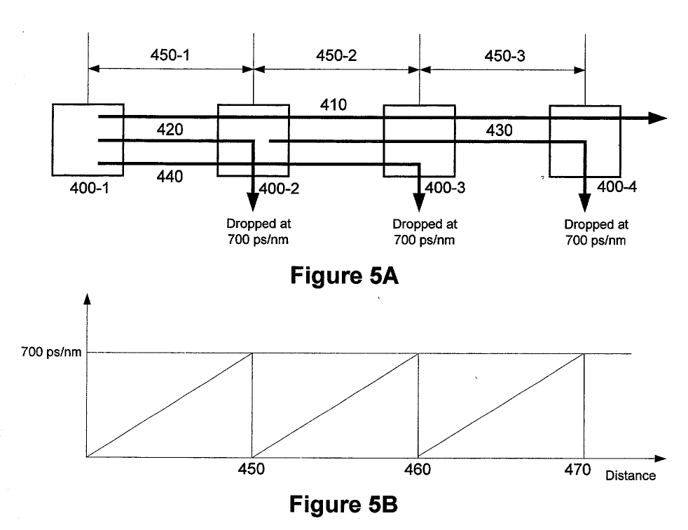

FIG. 5A shows an illustrative section of a transmission line of a mesh optical network with four re-configurable nodes 400-1, 400-2, 400-3 and 400-4. The transmission line can be divided into three sections: section 450-1 between nodes 400-1 and 400-2, section 450-2 between nodes 400-2 and 400-3 and section 450-3 be nodes 400-3 and 400-4 in accordance with an embodiment of the present invention. FIG. 5A shows four waves: wave 410 starts from node 400-1 and ends at node 400-4, wave 420 starts from node 400-1 and ends at node 400-2, wave 430 starts from node 400-2 and ends at node 400-4, wave 440 starts from node 400-1 and ends at node 400-3. Wave 420 is dropped at node 400-2 at 700 ps/nm based on fiber type and link length, Wave 440 is dropped at node 400-3 at 700 ps/nm and wave 430 is dropped at node 400-4 at 700 ps/nm.

FIG. 5B illustrates the dispersion map for express wave 410. The dispersion maps shows the dispersion from node 400-1 to 400-4 corresponding to sections 450-1 to 440-3. Wave 410 travels from node 400-1 and has a dispersion of 700 ps/nm (assume its has the same fiber type and length as wave 420) when it travels through section 450-1 and reaches node 400-2. In accordance with an embodiment of the present invention, wave 410 will be dispersion compensated to have a predetermined dispersion value (assume zero ps/nm) as illustrated as point 450 in FIG. 5B. Wave 410 has a dispersion of 700 ps/nm when it travels through section 450-2 and reaches node 400-3, and will be dispersion compensated to have zero ps/nm as illustrated as point 460 in FIG. 5B. Wave 410 has a dispersion of 700 ps/nm (due to different fiber type and/or length) when it travels through section 450-3 and reaches node 400-4, and will be dispersion compensated to have zero ps/nm as illustrated as point 470 in FIG. 5B. So in accordance with the illustrative embodiments of the present invention, for a section so defined such as section 440-1 in FIG. 5A, in either one of the two nodes 400-1 or 400-2 (for simplicity, use node 400-2), any wavelength traveling through section 450-1 will have a predetermined dispersion value: wave 420 which drops at node 400-2 has a dispersion of 700 ps/nm but the dispersion value can be altered by using a in-line DCF; wave 410 which passes through section 450-1 has a dispersion of 700 ps/nm when it enters node 400-2 and has a predetermined dispersion (such as zero ps/nm) using the proposed dispersion compensation when it exits node 400-2. By doing this, the dispersion for the waves traveling though a section can be determined independently from each other.

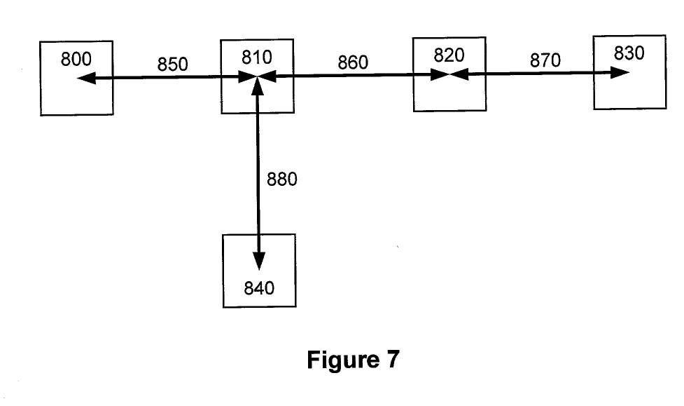

The dispersion compensation for the express waves in the re-configurable nodes in accordance with the invention can be done using a variety of technologies, such as a dispersion compensation fiber (DCF). The re-configurable optical nodes in FIG. 3, FIG. 4A, FIG. 4B and FIG. 5A can be a 2-degree node such as an Optical Add/drop Node (OADN) which can access 0-100% of the wavelengths in the optical signal carried in the transmission line, or an Optical Equalization Node (OEQN) which can access 100% of the wavelengths in the optical signal carried in the transmission line; or a multiple degree (larger than 2) Optical Junction Node (OJN). FIG. 7A shows an OADN with DCF to provide dispersion compensation for the express waves in accordance with one embodiment of the invention. OADN 500 has an optical signal 510 with a plurality of wavelengths passing through it. The optical signal 510 may be amplified by an optical amplifier 520 before passing through a device 540 to drop some (0-100%) wavelengths 570 in the optical signal 510. 540 can be a selective optical filter. The express waves 590 will continue to pass through a dispersion compensation device such as DCF 560 so to have a predetermined dispersion value such as zero ps/nm before it combines with added waves 580 via a device 550 such as an optical filter. The combined optical signal may be further amplified by an optical amplifier 530.

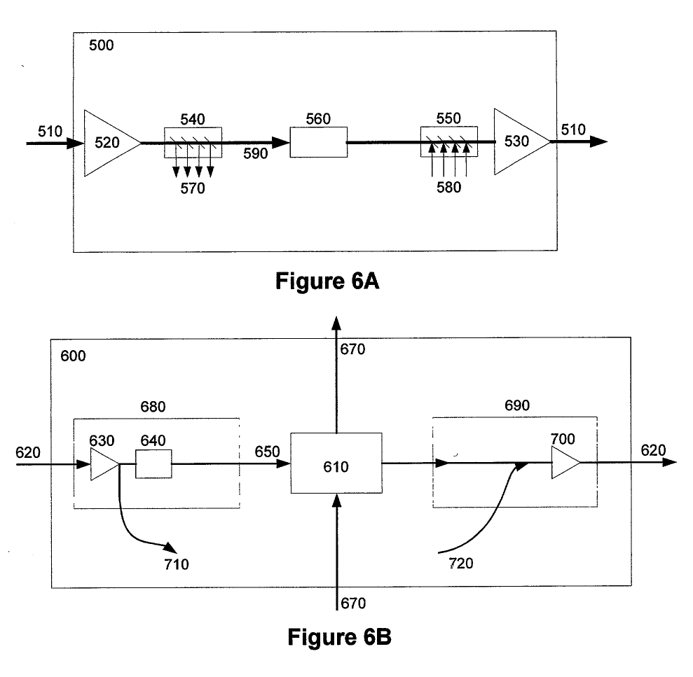

FIG. 6B shows an OJN with DCF to provide dispersion compensation for the express waves in accordance with another embodiment of the invention. OJN provides an optical cross connections for DWDM signals from different fibers connected to it via ports. Each fiber connection port is called a degree. OJN 600 is a 4-degree OJN which provides connections for different fibers carrying optical signal 620 and 670. OJN 600 has a first device 680 for dropping local waves 710 and a second device 690 for adding local waves 720 to optical signal 620. The express waves 650 from optical signal 620 after dropping local waves 710, and express waves from other fibers 670 are directed and allocated to different fibers via a third device 610, which can be an optical cross connect or an optical switch. The first device 680 may further include an amplifier 630 to amplify optical signal 620 before dropping local waves 710 and a dispersion compensating unit 640 (such as a DCF) to make express waves 650 have a predetermined dispersion value (such as zero ps/nm). Note that the dispersion compensation unit 640 can provide dispersion compensation to express wave 650 in a variety of ways: 640 can be implemented (such as using DCF) to compensate a whole fiber carrying express waves 650 or express waves 650 can be decomposed using a device such as demultiplexer so a series of parallel dispersion compensation units (such as multiple DCFs) can provide per wave or per band dispersion compensation to the decomposed express waves. The unit 640 can also be implemented as a dispersion equalization device which can eliminate the wavelength dependence of the residual dispersion of the express waves due to the mis-match of the dispersion slope between the transmission fibers and in-line DCFs in the reconfigurable sections. The express wave 650, after passing through device 610, will combine with local added waves 720 in device 690. To keep signal integrity and quality, the combined signal can be amplified further by amplifier 700. Note that optical signal 670 is also connected to 610 via devices 680 and 690, which are not shown in FIG. 6B. An OEQN can be defined as a two-degree OJN, in other words, an OJN with two ports connected to two fibers.

FIG. 7 illustrates an optical network with a plurality of re-configurable nodes 800, 810, 820, 830 and 840. The network can be divided into sections 850, 860, 870 and 880 between a pair of re-configurable nodes in accordance with an embodiment of the present invention. For any section, such as 850 between nodes 800 and 810, at either node 800 or 810 such as a node illustrated in FIG. 4B, the wavelengths can be classified into dropped waves like 320 in FIG. 4B, added waves like 330 in FIG. 4B and express waves like 310-1 and 310-2 in FIG. 4B. For each section, the transmission impairment parameters can be calculated and saved in the network.

To use section 850 as example, the linear residual dispersion design and calculation is based on fiber types, fiber lengths, DCF type and DCF values (assume DCF is used) at each section. For example, the dispersion for dropped waves 320 in FIG. 4B is designed to be the optimized residual dispersion at 700 ps/nm. For simplicity, assume zero pre-compensation, the added waves 330 in FIG. 4B will have zero ps/nm dispersion. The express waves 310-1 and 310-2 will be dispersion compensated after dropping waves 320 in accordance with the present invention as shown in FIG. 6A and FIG. 6B to have a predetermined dispersion value such as zero ps/nm. So the chromatic dispersion value for various waves (added, dropped, express) after passing section 850 can be obtained and stored in either node 800 or 810, and furthermore these linear chromatic dispersion values will be independent from each other among the sections. The chromatic dispersion of any lighpath can be calculated using stored chromatic dispersion at each section along the lightpath. For example, the chromatic dispersion for a lightpath traveling across M sections can be calculated as:

$$CD\_lightpath = {\sum }_{i}^{M - 1} CD\_express \_wave \_i + CD\_drop \_wave \_M \qquad ( 1 )$$

For re-configurable nodes shown in FIG. 4B, CD_lighpath=CD_dropwave_M=700 ps/nm with CD_express_wave_i=0 ps/nm (i=1, . . . , M−1).

Section OSNR for each section is defined as the ratio of the channel output power at the section over accumulated ASE noise of the optical amplifiers within the section. It is determined by the span loss, amplifier type and the channel output power and thus it can be determined from the transmission impairment parameters in the section and thus is independent of other sections. For example, the following formula can be used to calculate OSNR (in linear unit; OSNR is often in dB unit for transmission performance calculation such as in FIG. 2A) at each section k with n spans:

$$OSNR\_k = \frac{1}{hvB {\sum }_{i}^{n} \frac{NF\_i \_k \times G\_i \_k}{P\_out \_i \_k}} \qquad ( 2 )$$

Where NF_i_k, G_i_k and P_out_I_k are the noise figure, the gain and channel output power at the amplifier i, respectively. P_out_I_k is determined by the nonlinear impairments which will be described as below. h and v is the physical constances. B is optical bandwidth.

For lightpath which is transmitted across M sections, the OSNR can be calculated by the following formula:

$$\frac{1}{OSNR\_lightpath} = {\sum }_{i}^{M} \frac{1}{OSNR\_i} \qquad ( 3 )$$

Still referring to FIG. 7, the nonlinear impairments for each section such as section 850 not only depend on signal power but also other factors like channel spacing, channel plan, to name a few. As shown in FIG. 2A, one or multiple discrete points or even a continues range of signal power (the signal power can be accessed and adjusted via the re-configurable nodes such as node 800 for section 850) can be obtained which will offer acceptable signal performance (like acceptable OSNR, BER or Q-value) when the optical signal transmits along the section by considering other factors such as channel spacing (e.g.: 25 GHz, 50 GHz), channel counts (e.g.: 40 waves, 80 waves, 160 waves) as well as channel plan etc. In other words, these nonlinear impairment factors such as Signal Power, Channel Spacing and Channel Plan can be different in different sections in order to achieve the acceptable nonlinear impairments for different fiber types deployed in different sections. The trade-off relationship between signal performance (OSNR, BER, Q-value etc.) and nonlinear impairments can be in a variety of forms such as a list, a formula, a table or an array including such variables: Signal Power, Channel Spacing, Channel Plan, Fiber Type, DCF Type, Signal Performance (OSNR, BER, Q-value etc.). These nonlinear impairment parameters can also be either off-line pre-calculated or on-line calculated and saved in either node 800 or 810. Noticeably, like liner impairments, these nonlinear impairment parameters will also be independent from each other among the sections.

The linear and nonlinear impairment parameters can be saved along with other section parameters such as bandwidth, available wavelengths and can be disseminated to the nodes in the network via a routing protocol such as Open Shortest Path First (OSPF). The section parameters or attributes so obtained can be used for a variety of applications such as routing and signaling, network performance monitoring and network feedback control. With this invention, the physical constraints like transmission impairments can be incorporated into lighpath discovery due to traffic demand or optical restoration/protections in a complex re-configurable optical network. For example, when the available lightpaths are found for particular optical connections, their optical performance parameters (such as linear OSNR, linear residual dispersion and nonlinear impairment) can be calculated based on the stored data as described above. With the predetermined criteria based on the network requirements (such as minimum OSNR, required residual dispersion window, and maximum nonlinear impairment), optical performance of the available lightpath can be determined and the optical connections can be quickly established with the required transmission performances.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved. It is intended that the present invention be limited only to the extent required by the appended claims and the applicable rules of law.

What is claimed is:

1. A method of dispersion compensation for an optical network with a plurality of re-configurable nodes having an optical fiber transmission line, carrying an optical signal with a plurality of wavelengths, comprising:
dividing said optical fiber transmission line into a plurality of sections, each section located between a pair of said plurality re-configurable nodes;
for each said section, at either one of said pair of nodes:
classifying said plurality of wavelengths into a first set of added waves, a second set of dropped waves and a third set of express waves;
providing a first predetermined dispersion compensation to said third set of express waves so that said third set of express waves have a second predetermined dispersion.

2. The method in claim 1 wherein the determined dispersion values for said sections are independent from each other.

3. The method in claim 1 wherein said second set of dropped waves is further dispersion compensated to have a predetermined dispersion value.

4. The method in claim 3 wherein the second set of dropped wave is further dispersion compensated via an in-line Dispersion Compensation Fiber (DCF).

5. The method in claim 1 wherein said nodes include an Optical Junction Node (OJN).

6. The method in claim 1 wherein said nodes include an Optical Equalization Node (OEQN).

7. The method in claim 1 wherein said nodes include an-s Optical Add/Drop Node (OADN).

8. The method in claim 1 wherein a magnitude of said first predetermined dispersion compensation depends on network physical parameters.

9. The method in claim 8 wherein the network physical parameters include fiber type, fiber length, span loss, amplifier type and dispersion compensation types.

10. The method in claim 1 wherein a value of said second predetermined dispersion is zero.

11. The method in claim 1 wherein said step of providing a first predetermined dispersion compensation is via a Dispersion Compensation Fiber.

12. The method in claim 1 wherein said step of providing a first predetermined dispersion compensation is via a Fiber Bragg Gratings (FBGs).

13. A method of determining linear impairment parameters for an optical network with a plurality of re-configurable nodes having an optical fiber transmission line carrying an optical signal having a plurality of wavelengths, said method comprising:
dividing said optical fiber transmission line into a plurality of sections, wherein each section is located between a pair of said plurality re-configurable nodes; and
for each said section:
determining linear impairment parameters.

14. The method in claim 13 wherein said linear impairment parameters include chromatic dispersion, and wherein the method further comprises for each section:
at either one of said pair of nodes bounding the section:
classifying wavelengths passing through said section into a first set of added waves, a second set of dropped waves and a third set of express waves; and
determining dispersion values for said first set, second set and third set of waves.

15. The method in claim 14 wherein said step of determining dispersion values for said first set added waves, comprising determining the dispersion value for said first set of added waves to be zero ps/nm.

16. The method in claim 14 wherein the determining of dispersion values for said second set of dropped waves depends on fiber types and section length in the optical network.

17. The method in claim 13 wherein said linear impairment parameters include section OSNR.

18. A method of determining nonlinear impairment parameters for an optical network with a plurality of re-configurable nodes having an optical fiber transmission line, carrying an optical signal, said method comprising:
dividing said optical fiber transmission line into a plurality of sections, wherein each section is located between a pair of said plurality re-configurable nodes;
for each said section:
determining a trade-off relationship between an optical performance metric and nonlinear impairment impact for said optical signal when traveling through said section.

19. The method in claim 18 wherein said trade-off relationship is represented in the form of a list.

20. The method in claim 18 wherein said trade-off relationship is represented in the form of a table.

21. The method in claim 18 wherein said trade-off relationship is represented in the form of a formula.

22. A re-configurable optical node with a plurality of ports connected to a plurality of fibers, each carrying a plurality of wavelengths, for each pair of said plurality fibers, said node comprising:
a first device for dropping a first set of waves from said wavelengths;
a second device for adding a second set of waves to said wavelengths;
a third device located between said first and second device for directing a third set of express waves; and
a dispersion compensating device locating between said first device and said third device for providing a predetermined dispersion compensation to said third set of express waves.

23. The re-configurable optical node in claim 22 wherein said first device is a decoupler.

24. The re-configurable optical node in claim 22 wherein said second device is a coupler.

25. The re-configurable optical node in claim 22 wherein said third device is an optical cross connect.

26. The re-configurable optical node in claim 22 wherein said dispersion compensating device is a Dispersion Equalization Device.

27. A re-configurable optical node in an optical network carrying an optical signal with a plurality of wavelengths, said optical node comprising:
a first device for decomposing said optical signal and optionally dropping a first set of waves from said wavelengths;
a second device for combining said wavelengths into said optical signal and optionally adding a second set of waves to said wavelengths; and
a dispersion compensating device locating between said first device and said second device for providing a predetermined dispersion compensation to a third set of express waves.

28. A method for routing in an optical network having a plurality of re-configurable nodes having an optical fiber transmission line, said method comprising:
dividing said optical fiber transmission line into a plurality of sections, wherein each section is located between a pair of said plurality re-configurable nodes;
defining a set of attributes for said sections, wherein said attributes includes transmission impairments parameters; and
disseminating said attributes to said nodes in said optical network.

29. The method in claim 28 wherein said transmission impairments parameters include linear impairments parameters;

30. The method in claim 28 wherein said transmission impairments parameters include nonlinear impairments parameters;

31. The method in claim 29 wherein said linear impairments parameters include section Optical Signal Noise Ratio (OSNR).

32. The method in claim 29 wherein said linear impairments parameters further include chromatic dispersion.

33. The method in claim 28 wherein said step of disseminating attributes is via the Open Shortest Path First (OSPF) protocol.

34. A method for determining a lightpath for a mesh optical network with a plurality of re-configurable nodes and a plurality of sections, each having a plurality of transmission impairment attributes, said method comprising:
identifying a first node and a second node in response to a request for establishing a path with required performance requirements;
finding a set of sections from said plurality of sections, said set of sections satisfying pre-determined optical performance requirements based on said section transmission impairment attributes;
finding a path between said first and second node from said set of sections;

35. The method in claim 34 wherein said step of finding a path further includes checking path residual dispersion for paths.

36. The method in claim 34 wherein said step of finding a path further includes checking said path OSNR.

37. The method in claim 34 wherein said step of finding a path further includes checking path nonlinear impairment parameters for paths.

38. The method in claim 34 wherein said step of finding a path further includes optimizing network performance via a pre-defined performance criteria.
